(19) United States
(12) Patent Application Publication
(10) Pub. No.: US 2010/0241626 A1
(43) Pub. Date: Sep. 23, 2010

(54) CYBERTAG FOR LINKING INFORMATION TO DIGITAL OBJECT IN IMAGE CONTENTS, AND CONTENTS PROCESSING DEVICE, METHOD AND SYSTEM USING THE SAME

(75) Inventors: Hyung-Kyu Lee, Daejeon-city (KR); Jong-Wook Han, Daejeon-city (KR); Kyo-Il Chung, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/443,367

(22) PCT Filed: Sep. 21, 2007
(86) PCT No.: PCT/KR07/04642

§ 371 Date: Mar. 27, 2009

(30) Foreign Application Priority Data
Sep. 29, 2006 (KR) 10-2006-0096433

(51) Int. Cl. G06F 17/30

(52) U.S. Cl. 707/736; 707/769; 707/E17.044; 707/E17.014

(57) ABSTRACT

A CyberTAG for linking information to a digital object in an image contents, and an image contents display device, a method and a system using the same are provided. The CyberTAG includes: a tag ID field which serves to identify the digital object in the image contents and to link the digital object to additional information of the digital object; an object generation location field which serves to identify a location at which the digital object is generated while the image contents is displayed; a time field which serves to identify a time when the digital object appears while the image contents is displayed; and a modification value field which serves to trace the location of the digital object from when the digital object is generated to when the digital object disappears.

### TECHNICAL FIELD

The present invention relates to a CyberTAG for linking a digital object in image contents to information, and an image contents display device and method to which the CyberTAG is applied, and more particularly, to a CyberTAG, which is defined in the present invention so as to create various fusion services of broadcasting and communication services, identify various pieces of information on objects in broadcast or distributed image contents, and apply the information, and an application device, a method, and a system using the same.

This work was supported by the IT R&D program of MIC/IITA [2006-S-067-01, the development of security technology based on device authentication for ubiquitous home network].

### BACKGROUND ART

Recently, schemes for fusing various different types of networks have been actively developed, and will soon be trialled to explore new services such as a fusion of broadcasting and communication services. Accordingly, in the near future, users will be able to use any terminal to access network resources and information at any time and place.

Users who watch broadcasting contents, moving pictures and images through a PC often want to obtain additional information on various digital objects (a person, an object, a product, and the like) included in the image contents. It is difficult to include the information in the image contents due to constraints such as the capacity of a file or system.

Accordingly, a technique is needed for easily searching for the additional information by identifying the information on the digital object. Current techniques related to processing contents data include the Moving Picture Experts Group (MPEG) technique, the Joint Photographic Experts Group (JPEG) technique, and the like. But there is no service using the CyberTAG defined in the present invention.

As this technique is developed, broadcasting contents is transmitted to users through various network infrastructures, and contents data is processed by the techniques of processing moving picture data such as MPEG or still picture data such as JPEG data.

Existing techniques, MPEG 4, MPEG 7, and MPEG 21, will now be described.

The MPEG 4 technique was developed in 1998 for transmitting moving pictures at a low transmission rate. The important feature of MPEG 4 is that only desired or important objects are transmitted, by classifying image data into objects, so as to embody a moving picture with a slow transmission rate of 64 or 192 kbps.

MPEG 4 has been used for multimedia communication, video conferencing, computers, broadcasting, movies, education, remote monitoring, among other applications, in the Internet wired network as well as wireless networks such as mobile communication networks. MPEG 4 compression/decoding is also used in DivX, XviD, 3ivX. However, the core of MPEG 4 is not the compression but the aforementioned separation into objects.

MPEG 4 does not define a method of linking an object to additional information on the object.

MPEG 7 is a standard for describing contents, not for encoding but for searching for information, unlike MPEG 1, MPEG 2, and MPEG 4. MPEG 7 allows desired multimedia data to be searched for on a web page by inputting information on the color and shape of an object, like a technique of searching for a desired document by inputting a keyword.

MPEG 7 allows voice, image or composite multimedia data to be easily extracted from a database, using standards related to a description technique for searching for the color and texture of an image, the size of an object, the object in the image, backgrounds, mixed objects, and the like. Here, image information includes information on still images, graphics, audio, and moving pictures.

In an audio field, for example, when part of a melody is input, a function is provided for searching for a music file which includes or is similar to the part of the melody. In a graphics field, for example, when a diagram is input, a function is provided for searching for graphics or logos which include or are similar to the diagram. In an image contents field, for example, when an object or a color, texture, or an action of an object is input, or when part of a scenario is described, a function is provided for searching for contents which includes the same.

Accordingly, MPEG 7 can be applied to editing multimedia information, classifying image and music dictionaries in a digital library, guiding a multimedia service, selecting broadcasting media such as radio or TV, managing medical information, searching shopping information, a geographic information system (GIS), and the like.

However, MPEG 7 is used to search for multimedia contents, and does not provide a process of searching for information on digital objects in multimedia contents.

MPEG 21 aims to determine international standards for trading multimedia contents through electronic commerce. Consistent international standards which can be effectively used for through all the processes of producing and distributing multimedia contents are being determined in consideration of independently developed techniques.

Currently, MPEG 21 is referred to as digital rights management (DRM). MPEG 21 aims to prepare international standards for companies such as Microsoft. Accordingly, MPEG 21 is a management framework for contents, and does not define a management structure with respect to information on objects in the contents.

As described above, existing techniques related to moving pictures relate to technical standards about an editing operation, a searching operation, and a distributing operation, and the like. However, these techniques do not apply to additional information on objects in moving pictures.

### DISCLOSURE OF INVENTION

### Technical Problem

The present invention provides a CyberTAG which allows users to easily access information on digital objects included in an image contents such as broadcast or distributed moving pictures or photographs.

The present invention also provides an encoder which inserts CyberTAGs into digital objects in an image contents so as to distribute much information on digital objects existing in digital networks.

The present invention also provides a contents display device which allows users to easily access information on digital objects included in an image contents, and a method thereof.

The present invention also provides a system for providing additional information on a digital object in an image contents, which allows information to be distributed using CyberTAGs.

### Technical Solution

According to an aspect of the present invention, there is provided a CyberTAG including: a tag ID field which serves to identify the image contents and the digital object in the image contents and to link the digital object to additional information of the digital object; an object generation location field which serves to identify a location at which the digital object is generated while the image contents is displayed; a time field which serves to identify a time when the digital object appears while the image contents is displayed; and a modification value field which serves to trace the location of the digital object from when the digital object is generated to when the digital object disappears.

According to another aspect of the present invention, there is provided a contents processing device, which provides additional information on a digital object in an image contents, including: a CyberTAG browser which displays the image contents, receives a selection of a digital object in the image contents from a user, and displays additional information on the selected digital object to the user; a CyberTAG processing unit which serves to search for and identify the CyberTAG linked to the selected digital object; and a CyberTAG communication unit which serves to receive the additional information from an information server including the additional information by using the CyberTAG identified by the CyberTAG processing unit.

According to another aspect of the present invention, there is provided a method of providing additional information on a digital objects in an image contents, the method including: displaying the image contents and receiving a selection of a digital object in the image contents from a user; searching for and identifying the CyberTAG linked to the selected digital object; receiving additional information from an information server including the additional information by using the CyberTAG identified in the identifying of the CyberTAG; and displaying the additional information to the user.

According to another aspect of the present invention, there is provided a system for providing additional information on a digital object in an image contents, the system including: an encoder which inserts the CyberTAG into the image contents; a contents processing device which displays the image contents into which the CyberTAG is inserted and provides additional information on a digital object in the image contents; and an information server which provides the additional information when the contents processing device requests the additional information.

### ADVANTAGEOUS EFFECTS

According to an embodiment of the present invention, the additional information on the digital object can be effectively linked to the image contents. The additional information on the digital object in the image contents can be speedily and conveniently provided to a user.

In addition, according to an embodiment of the present invention, the image contents provider can perform an advertising business with respect to various products without a real commercial film (CF). A sales strategy of home shopping extends to various products from a single product through a cyber pavilion moving picture and the like.

In addition, according to an embodiment of the present invention, the broadcasting service provider can create a new business model by charging an owner of products or information which is indicated by the digital object in return for inserting the CyberTAG into the object.

In addition, according to an embodiment of the present invention, the CyberTAG technique enables various broadcasting/communication fusion services by suggesting a scheme of combining information with existing broadcasting techniques.

### DESCRIPTION OF DRAWINGS

FIG. 1 illustrates a frame structure of a CyberTAG according to an embodiment of the present invention;

FIG. 2 illustrates an example to which the CyberTAG shown in FIG. 1 is applied;

FIG. 3 illustrates the structure of a contents processing apparatus which provides additional information on a digital object in an image contents according to another embodiment of the present invention;

FIG. 4 is a flowchart illustrating a method of providing additional information of a digital object in an image contents to a user according to the other embodiment of the present invention; and

FIG. 5 illustrates a relation of usage of a CyberTAG according to the other embodiment of the present invention in various fields.

### BEST MODE

According to an aspect of the present invention, there is provided a CyberTAG including: a tag ID field which serves to identify the image contents and the digital object in the image contents and to link the digital object to additional information of the digital object; an object generation location field which serves to identify a location at which the digital object is generated while the image contents is displayed; a time field which serves to identify a time when the digital object appears while the image contents is displayed; and a modification value field which serves to trace the location of the digital object from when the digital object is generated to when the digital object disappears.

According to another aspect of the present invention, there is provided a contents processing device, which provides additional information on a digital object in an image contents, including: a CyberTAG browser which displays the image contents, receives a selection of a digital object in the image contents from a user, and displays additional information on the selected digital object to the user; a CyberTAG processing unit which serves to search for and identify the CyberTAG linked to the selected digital object; and a CyberTAG communication unit which serves to receive the additional information from an information server including the additional information by using the CyberTAG identified by the CyberTAG processing unit.

According to another aspect of the present invention, there is provided a method of providing additional information on a digital objects in an image contents, the method including: displaying the image contents and receiving a selection of a digital object in the image contents from a user; searching for and identifying the CyberTAG linked to the selected digital object; receiving additional information from an information server including the additional information by using the CyberTAG identified in the identifying of the CyberTAG; and displaying the additional information to the user.

According to another aspect of the present invention, there is provided a system for providing additional information on a digital object in an image contents, the system including: an encoder which inserts the CyberTAG into the image contents; a contents processing device which displays the image contents into which the CyberTAG is inserted and provides additional information on a digital object in the image contents; and an information server which provides the additional information when the contents processing device requests the additional information.

### MODE FOR INVENTION

Preferred embodiments of the present invention will now be described in detail with reference to the attached drawings.

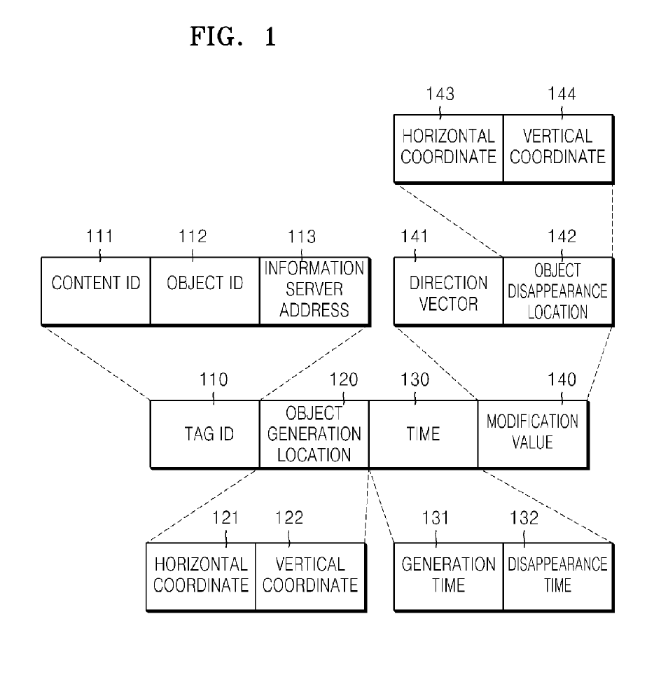

FIG. 1 illustrates a frame structure of a CyberTAG according to an embodiment of the present invention.

Referring to FIG. 1, the CyberTAG defined in the present invention includes a tag ID field 110, an object generation location field 120, a time field 130, and a modification value field 140.

The tag ID field 110 serves to identify image contents and a digital object in the image contents and link them to additional information.

The tag ID field 110 may include a contents ID field 111 which serves to identify the image contents displayed on a current browser, an object ID field 112 which serves to identify a digital object in the image contents, and a information server address field 113 which serves to allow an IP address of an information server including the additional information of the digital object to be recognized.

The object generation location field 120 serves to identify the location at which the digital object is generated while the image contents is being displayed, that is, to identify the location at which the digital object is initially displayed on a window.

In the present invention, the image contents includes moving pictures and still pictures such as photographs which are broadcast or distributed through IPTV and the like. The image contents is displayed by broadcasting, playing back, or displaying moving pictures, or displaying still pictures on a window of a user.

The object generation location field 120 may include a horizontal coordinate field 121 which represents the location of the digital object in the horizontal direction and a vertical coordinate field 122 which represents the location of the digital object in the vertical direction. The horizontal coordinate field 121 can represent start and end coordinates of unit pixels in which more than 50% of the area of each unit pixel is occupied by the digital object on the window in the horizontal direction. Similarly, the vertical coordinate field 122 can represent start and end coordinates of unit pixels in which more than 50% of the area of each unit pixel is occupied by the digital object on the window in the vertical direction.

The time field 130 serves to identify the time when the digital object appears on the window while the image contents is being displayed.

The time field 130 includes a generation time field 131 which represents the time when the digital object is generated while the image contents is being displayed and a disappearance time field 132 which represents the time when the digital object disappears while the image contents is being displayed.

The modification field 140 serves to trace the location of the digital object from when the digital object is generated to when the digital object disappears.

In the CyberTAG, a modification value of the object is used on the basis of the generation time and the disappearance time of the object because of a compression method of a moving picture. Compression such as MPEG improves efficiency by encoding the difference between the reference image frame and modified data, when the data constituting the reference image frame of the window does not change significantly.

Accordingly, the CyberTAG is prepared and encoded by applying the differential data to the data obtained when the digital object is generated in the reference image frame. Then, when the modification value of the CyberTAG is used so as to recognize the location of the object selected by the user, the location of the object is recognized by using interpolation or the like.

Generally, although a small error may occur in determining the locations of the objects by using the CyberTAGs, a unit pixel of the window is very small, and thus the accuracy in determining the location is not greatly influenced by the error.

The modification value field 140 may include a direction vector field 141 which represents the direction in which the location of the center of the digital object changes on the window, and an object disappearance location field 142 which represents a location at which the digital object disappears.

The direction vector field 141 in the modification value field 140 is calculated so as to display an approximate direction in which the location of the center of the digital object changes from when the digital object is generated on the window to when the digital object is disappeared from the window. The direction vector field 141 represents the number of pixels through which the center of the object passes horizontally and the number of pixels through which the center of the object passes vertically. At this time, movement to the right is indicated as (+) and to the left is indicated as (−). Only the pixels in which more than 50% of the area of the unit pixel is passed by the digital object are included in the aforementioned counting.

The object disappearance location field 142 in the modification value field 140 represents the location of the object when the digital object disappears from the window by using a horizontal coordinate field 143 and a vertical coordinate field 144.

Only some of the aforementioned fields of the CyberTAG may be used, as needed.

Additional fields may also be added. For example, when the contents is a still picture, since location movement according to time does not have to be represented, it is unnecessary to use the time field 230 and the modification field 240.

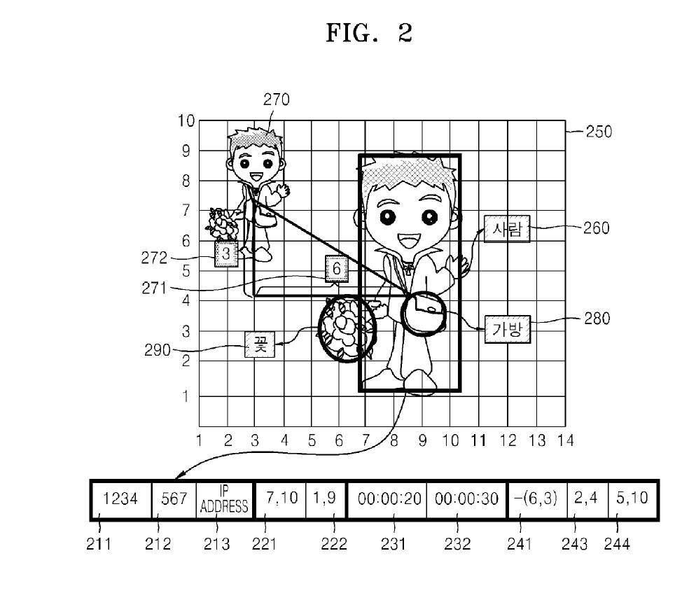

FIG. 2 illustrates an example to which the CyberTAG shown in FIG. 1 is applied.

Referring to FIG. 2, in order to indicate a person 260 among digital objects displayed on a window 250 of a user, the number (for example, 567) designated to the object is allocated to an object ID field 212. It is assumed that the image contents including the object is a movie. An ID (for example, 1234) indicating the title of the movie is allocated to the contents ID field 211 so as to be in linkage with the information server of the CyberTAG.

The window 250 is divided horizontally and vertically into unit pixels. Since horizontal coordinates of the pixels in which more than 50% of the area of each unit pixel is occupied by the digital object (the person 260) on the window ranges from 7 to 10, (7, 10) is recorded in the horizontal coordinate 221. Similarly, (1, 9) is recorded in the vertical coordinate 222.

In addition, in order to display that the person 260, which is the digital object, appears at 20 seconds and disappears at 30 seconds from when the image contents is played back, corresponding times are represented in a generation time field 231 and a disappearance time field 232.

It is assumed that the person on the window 250 moves from a location at which the person 260 appears to a location at which the person 270 disappears. At this time, since the location of the center of the person changes by 6 unit pixels 271 in the left direction and 3 unit pixels 272 in the upward direction, −(6, 3) or (−6, −3) is recorded in the direction vector field 241. The location of the person 270 at the disappearance time of the person is recorded respectively in horizontal and vertical coordinates 243 and 244 as (2, 4) and (5, 10).

As an example of an application of the CyberTAG, when the user selects one of moving paths of the person 260 and 270 between 20 seconds and 30 seconds from when the image contents is played back, additional information on the digital object is required by searching for the IP address recorded in the information server address field 213 of the CyberTAG which represent the digital object (the person) selected by the user. Then, the information server of the corresponding IP address transmits information on the person selected by the user to the user.

As another example of an application of the CyberTAG, when the user selects a bag 280, additional information on the bag 280 such as its brand, model name, size, weight, price, and where it can be purchased are transmitted to the user. When a flower 290 is selected, additional information can be transmitted to the user.

As described above, although FIG. 2 shows the example of a moving picture, in case of a still picture, a CyberTAG without the data of the time field and the modification field may be used.

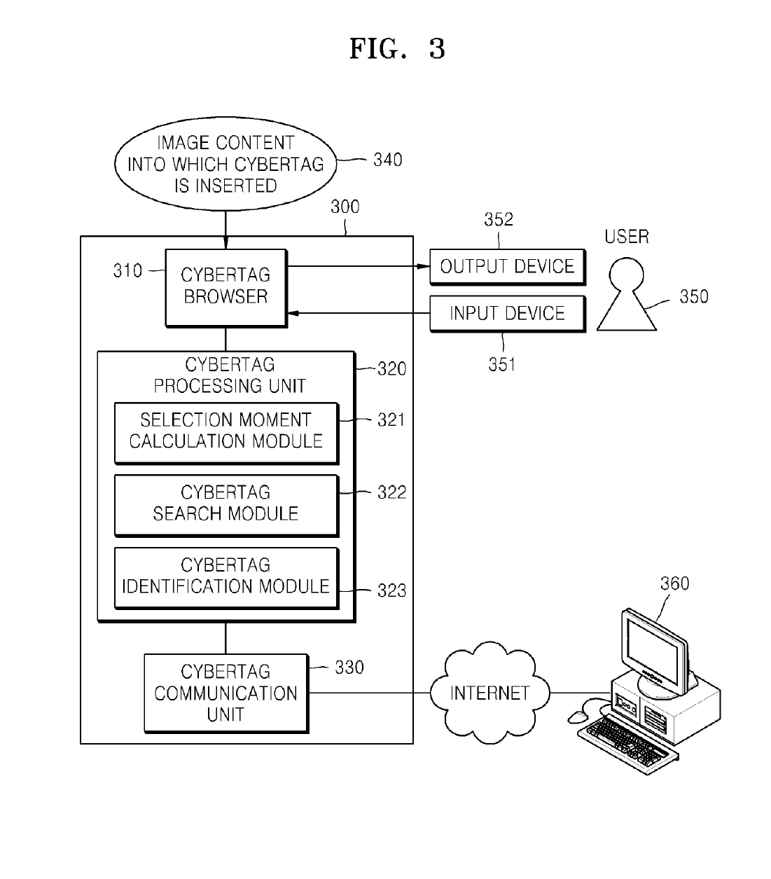

FIG. 3 illustrates the structure of a contents processing apparatus which provides additional information on a digital object in an image contents according to another embodiment of the present invention.

Referring to FIG. 3, a contents processing device 300 includes a CyberTAG browser 310, a CyberTAG processing unit 320, and a CyberTAG communication unit 330.

The CyberTAG browser 310 displays an image contents 340 through an output device 352 by decoding the image contents into which the CyberTAG is inserted. The CyberTAG browser 310 receives a selection of a digital object in the image contents from a user 350 through an input device 351.

When additional information on the selected digital object is input, the CyberTAG browser 310 also serves to display the additional information to the user 350.

The CyberTAG processing unit 320 serves to search for and identify the CyberTAG linked to the selected digital object.

The CyberTAG processing unit 320 may include a selection moment calculation module 321, a CyberTAG search module 322, and a CyberTAG identification module 323.

The selection moment calculation module 321 calculates the moment when the user selects the digital object, relative to the total display time. Then, the CyberTAGs in the image contents are searched for on the basis of the selection moment calculated by the CyberTAG search module 322. When the corresponding CyberTAG is found, the CyberTAG identification module 323 identifies the CyberTAG linked to the digital object selected by the user 350 by using location information, a modification value, and the like included in the found CyberTAG.

The CyberTAG processing unit 320 can identify the CyberTAG in a method of adding or subtracting the differential data to or from a reference image frame of the image contents, that is, the modification value of the CyberTAG is used.

The CyberTAG communication unit 330 serves to receive the additional information from an information server 360 including the additional information on the digital object selected by the user 350 by using the CyberTAG identified by the CyberTAG processing unit 320.

The CyberTAG communication unit 330 may request the information server 360 to provide the additional information by using a contents ID field, an object ID field, and an information server address field and receive the additional information from the information server.

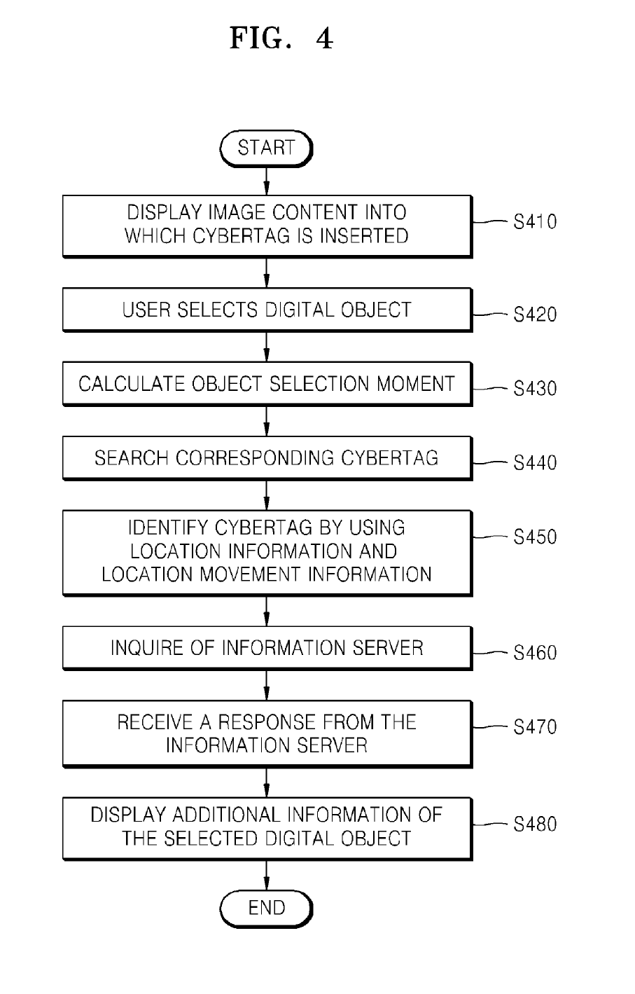

FIG. 4 is a flowchart illustrating a method of providing additional information of a digital object in an image contents to a user according to the other embodiment of the present invention. FIG. 4 will be described with reference to FIG. 3.

Referring to FIG. 4, when the user selects an object on a window, the contents ID and the object ID are extracted from the CyberTAG by using the fields other than the contents ID and the object ID. Accordingly, the additional information of the selected object is obtained.

Each operation will now be described in detail.

First, the CyberTAG browser 310 displays the image contents into which the CyberTAG is inserted to the user (S410).

Next, when the user selects an object through the CyberTAG browser 310 while viewing the image contents (S420), the CyberTAG processing unit 320 searches for and identifies the CyberTAGs (S430 to S450).

The moment when the user selects the digital object is calculated relative to the total display time of the image contents (S430). The CyberTAG in the image contents is searched for on the basis of the calculated selection moment (S440). The CyberTAG linked to the selected digital object is identified by using the location information and the location movement information (modification value) included in the found CyberTAG (S450).

In other words, the CyberTAG linked to the selected digital object is found from the sequentially found CyberTAGs by using the object location and the modification values. Specifically, when the object moves on the window, the corresponding CyberTAG is identified by using the object generation location field in the found CyberTAG and the object disappearance location field and the direction vector field in the modification value field.

Next, the information server having the additional information on the digital object selected by using the CyberTAG identified by the CyberTAG communication unit 330 is interrogated (S470). The address of the information server is obtained from the information server address field in the CyberTAG.

Next, the CyberTAG communication unit 330 receives a response including the additional information from the information server (S470).

Finally, the CyberTAG browser 310 allows users to receive the information service using the CyberTAG by displaying the additional information to the user (S480).

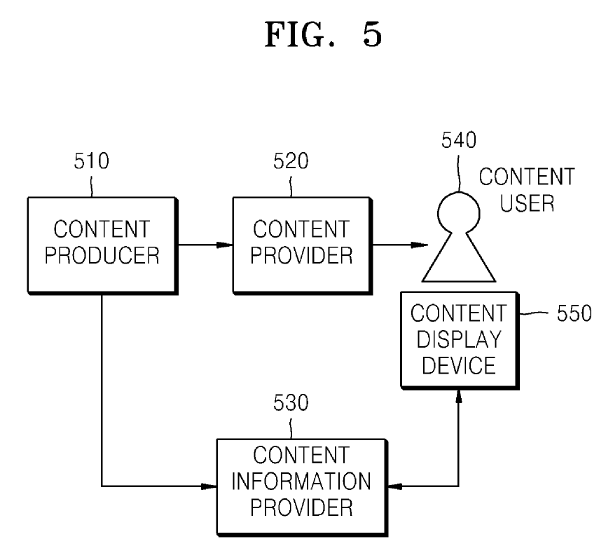

FIG. 5 illustrates a relation of usage of a CyberTAG according to the other embodiment of the present invention in various fields.

Referring to FIG. 5, the CyberTAG technique disclosed in the present invention may be applied to a field of encoding/decoding contents, a contents display field for browsing the object, and a CyberTAG information server field which provides an information service through identification of a CyberTAG.

A contents producer 510 may produce image contents into which a CyberTAG is inserted by using an encoder which inserts the CyberTAG into the image contents. The image contents is supplied to a contents provider 520 and a contents information provider 530.

A contents user 540 receives the image contents into which the CyberTAG is inserted from the contents provider 520, displays the image contents by using the contents processing device 550 shown in FIG. 3, and selects a desired digital object.

When the contents user 540 selects the digital object, the contents processing device 550 obtains the desired additional information by requesting the information server to provide the additional information and receiving the additional information from the information server in the contents information provider 530 side.

Although in FIG. 5, the contents producer 510, the contents provider 520, and the contents information provider 530 are separately illustrated, one company or a group may concurrently perform their various functions.

According to an embodiment of the present invention, the additional information on the digital object can be effectively linked to the image contents. The additional information on the digital object in the image contents can be speedily and conveniently provided to a user.

In addition, according to an embodiment of the present invention, the image contents provider can perform an advertising business with respect to various products without a real commercial film (CF). A sales strategy of home shopping extends to various products from a single product through a cyber pavilion moving picture and the like.

In addition, according to an embodiment of the present invention, the broadcasting service provider can create a new business model by charging an owner of products or information which is indicated by the digital object in return for inserting the CyberTAG into the object.

In addition, according to an embodiment of the present invention, the CyberTAG technique enables various broadcasting/communication fusion services by suggesting a scheme of combining information with existing broadcasting techniques.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and detail may be made therein without departing from the spirit and scope of the invention as defined by the appended claims. The exemplary embodiments should be considered in a descriptive sense only, and not for purposes of limitation. Therefore, the scope of the invention is defined not by the detailed description of the invention but by the appended claims, and all differences within the scope will be construed as being included in the present invention.

1. A CyberTAG for linking a digital object in an image contents to information, the CyberTAG comprising:
a tag ID field which serves to identify the image contents and the digital object in the image contents and to link the digital object to additional information of the digital object;
an object generation location field which serves to identify a location at which the digital object is generated while the image contents is displayed;
a time field which serves to identify a time when the digital object appears while the image contents is displayed; and
a modification value field which serves to trace the location of the digital object from when the digital object is generated to when the digital object disappears.

2. The CyberTAG of claim 1, wherein the tag ID field comprises:
a contents ID field which serves to identify the image contents;
an object ID field which serves to identify the digital object; and
an information server address field which provides an IP address of an information server including the additional information of the digital object.

3. The CyberTAG of claim 1, wherein the object generation location field includes:
a horizontal coordinate field which represents a location of the digital object in the horizontal direction on a window; and
a vertical coordinate field which represents a location of the digital object in the vertical direction on the window, and
wherein the horizontal coordinate field and vertical coordinates field are represented by start and end coordinates of unit pixels in which more than 50% of the area of each unit pixel is occupied by the digital object on the window.

4. The CyberTAG of claim 1, wherein the time field comprises:
a generation time field which represents a time when the digital object is generated while the image contents is displayed; and
a disappearance time field which represents a time when the digital object disappears while the image contents is displayed.

5. The CyberTAG of claim 1, wherein the modification value field comprises:
a direction vector field which represents a direction in which the location of the center of the digital object changes; and
an object disappearance location field which represents a location at which the digital object disappears.

6. A contents processing device, which provides additional information on a digital object in an image contents, comprising:
a CyberTAG browser which displays the image contents, receives a selection of a digital object in the image contents from a user, and displays additional information on the selected digital object to the user;
a CyberTAG processing unit which serves to search for and identify the CyberTAG linked to the selected digital object; and
a CyberTAG communication unit which serves to receive the additional information from an information server including the additional information by using the CyberTAG identified by the CyberTAG processing unit.

7. The contents processing device of claim 6, wherein the CyberTAG processing unit comprises:
a selection moment calculation module which calculates a moment when the user selects the digital object relative to the total display time of the image contents;
a CyberTAG search module which searches for a CyberTAG in the image contents on the basis of the calculated selection moment; and
a CyberTAG identification module which identifies the CyberTAG linked to the selected digital object by using location information and location movement information included in the found CyberTAG.

8. The contents processing device of claim 6, wherein the CyberTAG processing unit identifies the CyberTAG in a method of adding or subtracting differential data to or from a reference image frame of the image contents.

9. The contents processing device of claim 6, wherein the CyberTAG communication unit receives the additional information from the information server by using the CyberTAG which includes, a contents ID field which identifies the image contents, an object ID field which identifies the digital object, and an information server address field which provides an IP address of an information server including the additional information.

10. A method of providing additional information on a digital object in an image contents, the method comprising:
displaying the image contents and receiving a selection of a digital object in the image contents from a user;
searching for and identifying the CyberTAG linked to the selected digital object;
receiving additional information from an information server including the additional information by using the CyberTAG identified in the identifying of the CyberTAG; and
displaying the additional information to the user.

11. The method of claim 10, wherein the searching for and identifying of the CyberTAG comprises:
calculating a moment when the user selects the digital object relative to the total display time of the image contents;
searching for the CyberTAG in the image contents on the basis of the calculated selection moment; and
identifying the CyberTAG linked to the selected digital object by using location information and location movement information included in the found CyberTAG.

12. The method of claim 10, wherein in the searching for and identifying of the CyberTAG, the CyberTAG is identified in a method of adding or subtracting differential data to or from a reference image frame of the image contents.

13. The method of claim 10, wherein in the receiving of the additional information, the additional information is obtained from information server by using the CyberTAG which includes, a contents ID field which identifies the image contents, an object ID field which identifies the digital object, and an information server address field which provides an IP address of an information server including the additional information.

14. An encoder inserting the CyberTAG of claim 1 into an image contents.

15. A system for providing additional information on a digital object in an image contents, the system comprising:
an encoder which inserts the CyberTAG into the image contents;
a contents processing device which displays the image contents into which the CyberTAG is inserted and provides additional information on a digital object in the image contents; and
an information server which provides the additional information when the contents processing device requests the additional information.
